(19) United States
(12) Patent Application Publication
(10) Pub. No.: US 2007/0077492 A1
(43) Pub. Date: Apr. 5, 2007

(54) Nickel oxyhydroxide, manufacturing method therefor, and alkaline primary battery

(76) Inventors: Fumio Kato, Osaka (JP); Munehisa Ikoma, Nara (JP)

Correspondence Address: MCDERMOTT WILL & EMERY LLP, 600 13TH STREET, N.W., WASHINGTON, DC, 20005-3096, US

(21) Appl. No.: 11/540,533

(22) Filed: Oct. 2, 2006

(30) Foreign Application Priority Data
Oct. 3, 2005 (JP) 2005-289794

(51) Int. Cl. H01M 4/52; C01G 53/04

(52) U.S. Cl. 429/223; 423/594.19

(57) ABSTRACT

A nickel oxyhydroxide having a β-type structure is used to greatly improve low-temperature discharge performance and pulse discharge performance under high-load of an alkaline primary battery including a positive electrode containing nickel oxyhydroxide. In the nickel oxyhydroxide having β-type structure, a half-width of a peak of the (001) plane is 0.2 to 0.49° in a powder X-ray diffraction, an average particle size (D₅₀) based on the secondary particle volume is 5 to 10 μm, and an average valence of nickel is 2.9 to 3.0.

### FIELD OF THE INVENTION

The present invention relates to nickel oxyhydroxides, a manufacturing method therefor, and an alkaline primary battery comprising a positive electrode including a nickel oxyhydroxide (such as nickel dry cell batteries).

### BACKGROUND OF THE INVENTION

Alkaline dry (primary) batteries have an inside-out structure: in a positive electrode case which also functions as a positive electrode terminal, cylindrical manganese dioxide positive electrode mixture pellets are disposed to closely contact the positive electrode case, and in a hollow of the cylindrical positive electrode mixture pellets, a gelled zinc negative electrode is disposed with a separator interposed therebetween. With the recent spread of digital devices, an electrical load of the devices in which these batteries are used is gradually increasing. Thus, batteries excellent in discharge performance under high load have been in demand. In view of such demand, Patent Document 1 proposed mixing nickel oxyhydroxide in a positive electrode mixture for achieving batteries excellent in discharge performance under high load. Such batteries are in actual use and widespread nowadays.

For the nickel oxyhydroxide usage, generally, a spherical nickel hydroxide used in alkaline storage batteries (secondary batteries) is oxidized by using an oxidant such as a sodium hypochlorite aqueous solution for the usage. The spherical nickel hydroxide is produced by crystallization, in which an aqueous solution including a nickel salt is neutralized with an aqueous alkaline solution. When nickel hydroxides are used in alkaline storage batteries, in view of securing charging performance, it is important that its crystallinity is made low to a certain degree. In this regard, for example, Patent Document 2 proposed a spherical nickel hydroxide with a FWHM (full width at half maximum) of 0.8° or more of a peak of the (101) plane in a powder X-ray diffraction. Additionally, as a synthesizing method for the nickel hydroxide other than the above crystallization, for example, Patent Document 3 proposed obtaining nickel hydroxide by directly oxidizing a simple substance of nickel (metallic nickel). However, the nickel hydroxide obtained by such method has very high crystallinity. Therefore, application of such nickel hydroxide to alkaline storage batteries is difficult.

In alkaline primary batteries as well, when crystallinity of nickel hydroxide, i.e., a starting material of nickel oxyhydroxide, is excessively high, the oxidation by an oxidant is difficult. In this regard, for example, Patent Document 4 proposed a nickel hydroxide with a FWHM of 0.3° or more of a peak of the (100) plane as a starting material.

The inventors of the present invention diligently examined nickel oxyhydroxides included in alkaline primary batteries. As a result, it was found that with a nickel oxyhydroxide having high crystallinity, discharge performance under high load of batteries improved. Accordingly, Patent Document 5 proposed a β-nickel oxyhydroxide with a FWHM of 0.6° or less of a peak of the (001) plane.

[Patent Document 1] Japanese Laid-Open Patent Publication No. Sho 57-72266

[Patent Document 2] Japanese Laid-Open Patent Publication No. Hei 9-139230

[Patent Document 3] U.S. Pat. No. 5,545,392

[Patent Document 4] Japanese Laid-Open Patent Publication No. Hei 11-246226

[Patent Document 5] Japanese Laid-Open Patent Publication No. 2005-71991

### BRIEF SUMMARY OF THE INVENTION

However, even with the usage of the β-nickel oxyhydroxide (a FWHM of about 0.5 to 0.6° of a peak of the (001) plane) as proposed in Patent Document 5, performance of alkaline primary batteries (such as nickel dry cell batteries) is not sufficient. Particularly, low-temperature discharge performance and pulse discharge performance under high-load, which are required for usage in digital cameras are insufficient.

To improve crystallinity of nickel oxyhydroxide, crystallinity of nickel hydroxide, i.e., a starting material, has to be improved: however, nickel hydroxide with high crystallinity is hardly obtained by conventional crystallization methods. Additionally, when nickel hydroxide as the starting material has high crystallinity, generally, oxidation by using an oxidant does not advance easily.

In view of the conventional problems as noted in the above, the present invention aims to improve low-temperature discharge performance and pulse discharge performance under high-load of alkaline primary batteries including nickel oxyhydroxide as a positive electrode active material.

Means for Solving the Problem

In view of the above conventional problems, the present invention provides a nickel oxyhydroxide having a β-type structure, wherein a FWHM of a peak of the (001) plane is 0.2 to 0.49° in a powder X-ray diffraction,

an average particle size (D₅₀) based on a secondary particle volume is 5 to 10 μm, and

an average valence of nickel is 2.9 to 3.0.

In the β-nickel oxyhydroxide having a FWHM of 0.2 to 0.49° of a peak of the (001) plane in a powder X-ray diffraction, the layer structure of primary particles (crystallite) in the direction along the c-axis is developed. This is advantageous in discharge under high-load (high-speed reduction reaction), in view of both proton diffusibility and electron conductivity. In the above β-nickel oxyhydroxide, by controlling the average particle size (D₅₀) of secondary particles and the average valence of nickel, low-temperature discharge performance and pulse discharge performance of alkaline primary batteries (such as nickel dry cell batteries) can be improved.

The BET specific surface area of the nickel oxyhydroxide is preferably 3 to 10 m²/g.

The nickel oxyhydroxide preferably includes 0.03 to 1 wt % of a metallic nickel relative to a total weight of the nickel oxyhydroxide.

Also, the nickel oxyhydroxide is preferably a solid solution including 0.1 to 10 mol % of at least one of cobalt and manganese relative to a total amount of the metal element included in the nickel oxyhydroxide.

The present invention also relates to a method for manufacturing a nickel oxyhydroxide having a β-type structure, the method comprising a step of:

chemically oxidizing a nickel hydroxide having a β-type structure,

wherein a FWHM of a peak of the (001) plane is 0.15 to 0.49°, a FWHM of a peak of the (100) plane is 0.15 to 0.3°, and a FWHM of a peak of the (101) plane is 0.2 to 0.6°, in a powder X-ray diffraction; and

an average particle size (D₅₀) based on the secondary particle volume is 5 to 10 μm.

Such nickel hydroxide (starting material) having the above physical properties is very hard to obtain by usual crystallization. However, for example, such nickel hydroxide can be produced by activating a simple substance nickel (metallic nickel) in an aqueous ammonia solution, and making it react with oxygen.

The BET specific surface area of the nickel hydroxide is preferably 3 to 10 m²/g.

The nickel hydroxide preferably includes 0.03 to 1 wt % of a metallic nickel relative to a total weight of the nickel hydroxide.

Also, the nickel hydroxide is preferably a solid solution including 0.1 to 10 mol % of at least one of cobalt and manganese, relative to a total amount of the metal element included in the nickel hydroxide.

[Effect of the Invention]

The present invention achieves an improvement in low-temperature discharge performance and pulse discharge performance under high-load of alkaline primary batteries including nickel oxyhydroxide as a positive electrode active material.

While the novel features of the invention are set forth particularly in the appended claims, the invention, both as to organization and content, will be better understood and appreciated, along with other objects and features thereof, from the following detailed description taken in conjunction with the drawings.

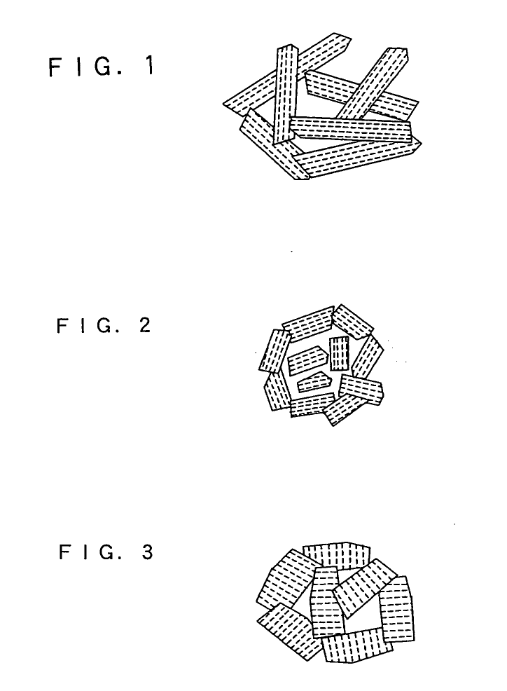

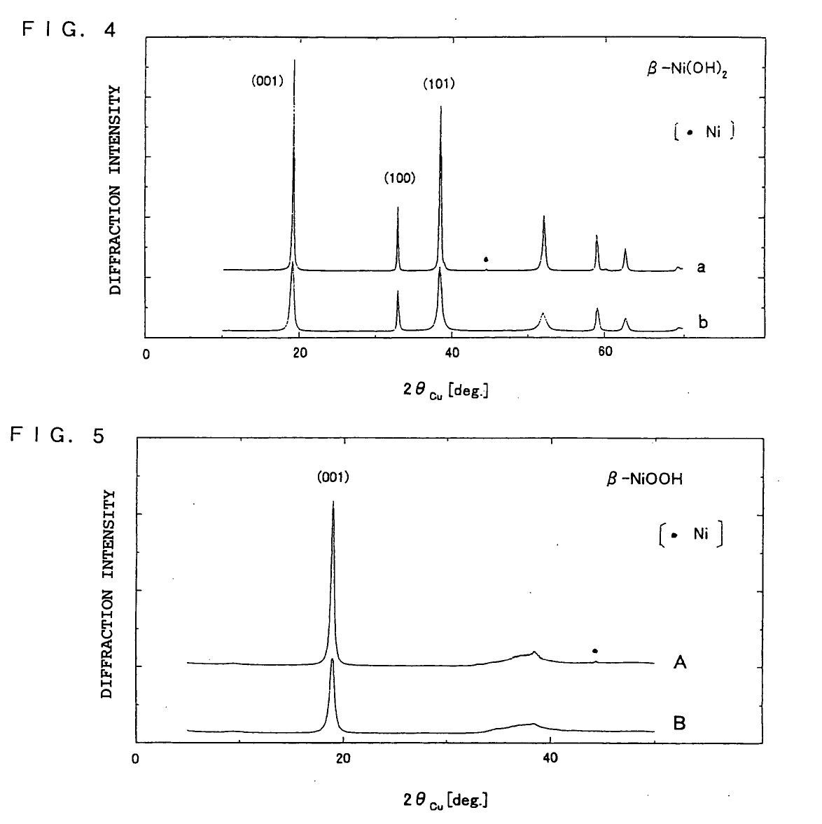

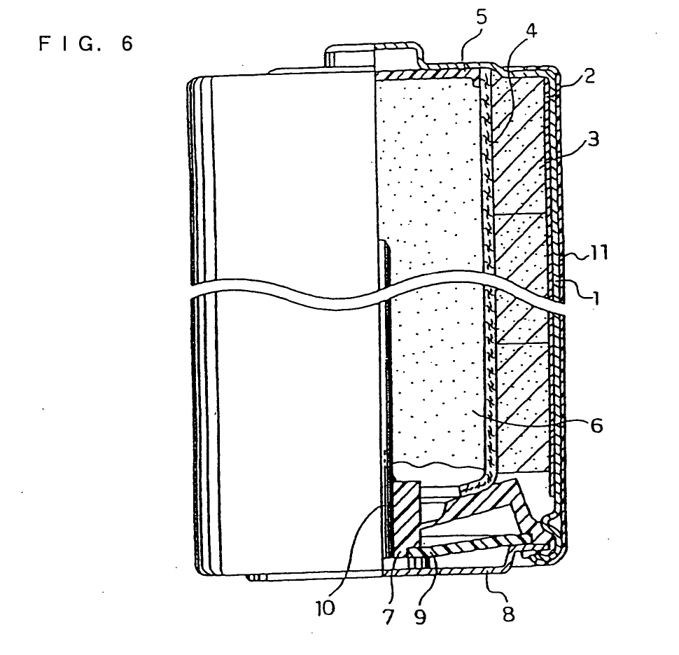

### BRIEF DESCRIPTION OF THE DRAWINGS

[FIG. 1] A diagram illustrating a particle structure of a nickel oxyhydroxide, in which a NiO₂ layer extends to a direction substantially perpendicular to the c-axis, and the layer structure is not developed to a direction along the c-axis.

[FIG. 2] A diagram illustrating a particle structure of a nickel oxyhydroxide, in which a NiO₂ layer does not extend to a direction substantially perpendicular to the c-axis, and the layer structure is not developed to a direction along the c-axis.

[FIG. 3] A diagram illustrating a particle structure of a nickel oxyhydroxide, in which a NiO₂ layer does not extend to a direction substantially perpendicular to the c-axis, and the layer structure is developed to a direction along the c-axis.

[FIG. 4] Powder X-ray diffraction patterns of nickel hydroxides “a” and “b” used in Example.

[FIG. 5] Powder X-ray diffraction patterns of nickel oxyhydroxides A and B used in Example.

[FIG. 6] A front view of an alkaline dry cell battery in an embodiment of the present invention, with a partial cross section.

### DETAILED DESCRIPTION OF THE INVENTION

The present invention provides:

a nickel oxyhydroxide having a β-type structure,

wherein a FWHM of a peak of the (001) plane is 0.2 to 0.49° in a powder X-ray diffraction,

an average particle size (D₅₀) based on a secondary particle volume is 5 to 10 μm, and

an average valence of nickel is 2.9 to 3.0; and

an alkaline primary battery comprising a positive electrode including the nickel oxyhydroxide.

In the nickel oxyhydroxide having the β-type structure (β-nickel oxyhydroxide), the NiO₂ layer is layered in the c-axis direction. In the nickel oxyhydroxide, an electrochemical reduction (discharge) reaction involves proton diffusion in the solid phase in a direction of the NiO₂ layer plane. In a β-nickel oxyhydroxide with a very small FWHM of 0.2 to 0.49° of a peak of the (001) plane in a powder X-ray diffraction, layers are developed in a direction along the c-axis of primary particles (crystallite). The NiO₂ layer is present in the crystal of the nickel oxyhydroxide, and the plane of the NiO₂ layer is the (001) plane.

FIGS. 1 to 3 are diagrams illustrating different particle structures in secondary particles of β-nickel oxyhydroxide. In FIGS. 1 to 3, dotted lines show the NiO₂ layer in primary particles, and a direction substantially perpendicular to the dotted lines is the c-axis direction. The primary particles gather to form a secondary particle as a whole. In the β-nickel oxyhydroxide in which the NiO₂ layer is not developed to the direction along the c-axis to a greater degree, there are cases in which the NiO₂ layer is extended to a direction of its plane (FIG. 1) and in which the NiO₂ layer is not extended (FIG. 2). When the NiO₂ layer is extended to the direction of its plane (FIG. 1), low-temperature discharge performance is maintained, because the electrical contacts between primary particles are kept. However, since the distance of proton diffusion becomes long in the primary particles (in the solid phase), pulse discharge performance that is greatly affected by the proton diffusion easily declines.

When the NiO₂ layer is not extended to the direction of its plane (FIG. 2), the distance of the proton diffusion is short in the primary particles, and the ends of the NiO₂ layer (edge plane) are present in many cases. Thus, the decline in pulse discharge performance is hardly caused by the influence from the proton diffusion. However, due to its small primary particle size, the primary particles are easily isolated in the center of the secondary particle. Therefore, the electrical contacts between the primary particles are easily weakened, being unable to achieve obtaining sufficient low-temperature discharge performance.

As opposed to such cases, the β-nickel oxyhydroxide used in the present invention, in which the NiO₂ layers are developed to the direction along the c-axis (FIG. 3) to a greater degree, ends of the NiO₂ layer (edge plane) are present in a higher probability. Therefore, the proton diffusibility improves. Also, due to a relatively large primary particle size, electrically isolated primary particles rarely exist. Thus, excellent low-temperature discharge performance and pulse discharge performance can be obtained. Especially, since the NiO₂ layer is not extended to a direction of its plane, proton diffusion distance in primary particles becomes short, making it the most ideal one.

The β-nickel oxyhydroxide with a FWHM of a peak of the (001) plane of below 0.2° is extremely hard to be produced. Also, with the β-nickel oxyhydroxide having a FWHM of a peak of the (001) plane of larger than 0.49°, the above preferable mechanism is not embodied, and due to the low crystallinity, sufficient performance improvement effects cannot be obtained. Therefore, the FWHM of a peak of the (001) plane of 0.2 to 0.49° is preferable.

When the average particle size (D₅₀) based on the secondary particle volume of the nickel oxyhydroxide is below 5 μm, the positive electrode mixture is hardly molded into pellets. Also, when the average particle size is over 10 μm, the degree of mixing with the conductive agent (such as graphite) is declined. Thus, low-temperature discharge performance and pulse discharge performance decline. Therefore, the average particle size (D₅₀) based on the secondary particle volume of 5 to 10 μm is preferable.

When the average valence of nickel in the nickel oxyhydroxide is below 2.9, the capacity per unit weight of the nickel oxyhydroxide (mAh/g) becomes small. Thus, the capacity of the battery to be obtained will decrease. Also, when the average valence of nickel exceeds 3.0, the proportion of the nickel oxyhydroxide having a γ-type structure included in the nickel oxyhydroxide increases. As a result, discharge performance under high load of alkaline primary batteries declines and it is not preferable.

The average valence of nickel in the nickel oxyhydroxide can be determined, for example, as in below.

(a) Determination of Nickel Weight Ratio in Nickel Oxyhydroxide

Nickel oxyhydroxide powder in an amount of for example 0.05 g is added to a concentrated nitric acid in an amount of for example 10 cm³ and the mixture is heated to dissolve the nickel oxyhydroxide powder. A tartaric acid aqueous solution in an amount of for example 10 cm³ and an ion-exchange water are added, and the volume of the entire mixture is adjusted to for example 200 cm³ to obtain a solution. The pH of the solution is adjusted by using ammonia water and acetic acid. Potassium bromate of for example 1 g is added, and cobalt ion and manganese ion (including doped element) that may cause a measurement error are oxidized to a higher state. While the solution is heated and stirred, an ethanol solution of dimethylglyoxime is added, to precipitate nickel (II) ion as a complex compound of dimethylglyoxime. Then, a suction filtration is carried out to collect the produced precipitate, and the precipitate is dried, for example, in an atmosphere of 110° C. The weight of the precipitate is measured, and the obtained weight is used to determine the nickel weight ratio included in the active material powder based on the formula below.
Nickel Weight Ratio={Weight of the Precipitate (g)×0.2032}/{Active Material Powder Sample Weight (g)}

Also, when the nickel oxyhydroxide powder is a solid solution including, for example, at least one of cobalt and manganese, first of all, the nickel oxyhydroxide is added to a nitric acid aqueous solution, heated, and dissolved to obtain a solution. For the obtained solution, an ICP emission spectrometry is carried out (using VISTA-RL manufactured by VARIAN, Inc), to determine cobalt and manganese.

(b) Determination of Nickel Average Valence By Redox Titration

Nickel oxyhydroxide powder in an amount of for example 0.2 g, potassium iodide in an amount of for example 1 g, and sulfuric acid in an amount of for example 25 cm³ are mixed and stirred to completely dissolve the powder. In this process, metal ions with a higher valence, that is, ions of nickel and the doped element (for example, cobalt ion and manganese ion), oxidize potassium iodide to iodine, and ions of nickel and the doped element are reduced to a valence of two. Afterwards, the mixture is allowed to stand for example 20 minutes, and an aqueous solution of acetic acid-ammonium acetate as a pH buffer solution and ion-exchange water are added to stop the reaction. The produced and released iodine is titrated with for example a 0.1 mol/L sodium thiosulfate aqueous solution. The titrated amount at this time reflects the amount of the metal ion with a valence of two or more as noted in the above.

Then, by using the weight ratio of nickel, cobalt, and manganese contents obtained in (a), the average valence of nickel included in the nickel oxyhydroxide can be determined, assuming the valence of metal in the nickel oxyhydroxide as a predetermined value (for example, setting the valence of cobalt as three, and the valence of manganese as four).

Nickel oxyhydroxide with a BET specific surface area of 3 m²/g or more can be produced easily. Also, a positive electrode including the nickel oxyhydroxide with a BET specific surface area of 10 m²/g or less can achieve appropriate liquid retention. At the time of injecting an electrolyte to a battery, a positive electrode does not swell easily, and excellent electrical contacts between the particles included in the positive electrode can be obtained. Thus, excellent low-temperature discharge performance and pulse discharge performance can be obtained. Therefore, the BET specific surface area of the nickel oxyhydroxide is preferably 3 to 10 m²/g.

The BET specific surface area of nickel oxyhydroxide depends mainly on a FWHM in a powder X-ray diffraction and an average particle size.

A positive electrode in the present invention preferably includes 0.03 to 1 wt % of a metallic nickel relative to a total weight of the nickel oxyhydroxide. By including the metallic nickel in addition to the nickel oxyhydroxide, electron conductivity further improves. As a result, excellent low-temperature discharge performance can be obtained. When the metallic nickel content relative to a total weight of the nickel oxyhydroxide is 0.03 wt % or more, further excellent effects can be obtained. The content of 1 wt % or less can achieve the ratio of the nickel oxyhydroxide in the positive electrode. As a result, excellent battery capacity can be obtained.

The metallic nickel content included in the positive electrode can be controlled by for example adjusting various conditions in the process of converting metallic nickel to nickel hydroxide. Also, the content can be determined by using for example a vibrating sample magnetometer.

The nickel oxyhydroxide is preferably a solid solution including at least one of cobalt and manganese in an amount of 0.1 to 10 mol % relative to a total amount of the metal element included in the nickel oxyhydroxide. When the nickel oxyhydroxide is a solid solution including at least one of cobalt and manganese, proton diffusibility in crystal at the time of discharge and electron conductivity of crystal can be improved. Therefore, excellent discharge performance can be obtained. Also, cobalt and manganese included in the solid solution of the nickel oxyhydroxide has an effect of increasing oxygen overvoltage in the nickel oxyhydroxide. Therefore, self-discharging of the nickel oxyhydroxide can be retarded, and excellent battery storage characteristics can be obtained.

When the content of at least one of cobalt and manganese in the solid solution of the nickel oxyhydroxide is 0.1 mol % or more relative to a total amount of the metal element included in the nickel oxyhydroxide, the above excellent discharge performance and storage characteristics can be obtained. The content of 10 mol % or less enables maintaining the proportion of the nickel oxyhydroxide included in the positive electrode. As a result, an excellent battery capacity can be obtained.

When at least one of cobalt and manganese included in the nickel oxyhydroxide in the present invention is regarded as Element M, the solid solution of the nickel oxyhydroxide including Element M refers to the nickel oxyhydroxide including the Element M in its crystal. To be specific, the solid solution can be any one of a solid solution in which at least a portion of nickel atom is replaced with Element M in the crystal of the nickel oxyhydroxide, and a solid solution in which Element M is intercalated in the crystal of the nickel oxyhydroxide. The above solid solution may include both the replaced Element M and the intercalated Element M.

In the present invention, known materials may be used for the positive electrode along with the above nickel oxyhydroxide. For example, as the positive electrode active material, a positive electrode mixture including a mixture of the solid solution of the nickel oxyhydroxide as in the above and manganese dioxide, graphite as a conductive agent, and an electrolyte may be used. These materials are mixed by a mixer and arranged to give a homogenous grain size, thereby obtaining granules. The granules are pressure-molded to give positive electrode mixture pellets, and these pellets can be used as a positive electrode. The average particle size of the manganese dioxide is preferably 30 to 50 μm. Additionally, the average particle size of the graphite is preferably 10 to 20 μm.

For the negative electrode and the separator as well, known materials may be used. For the negative electrode, for example, a gelled negative electrode obtained by mixing zinc powder or zinc alloy powder as a negative electrode active material, sodium polyacrylate as a gelling agent, and an electrolyte may be used. For the zinc alloy powder, for example, those including Bi, In, and Al may be used. The average particle size of the zinc powder or the zinc alloy powder is preferably 100 to 150 μm, for example.

For the electrolyte, for example, a potassium hydroxide aqueous solution may be used. The potassium hydroxide is preferably included in the aqueous solution in an amount of 30 to 40 wt %.

For the separator, for example, a composite fiber comprising vinylon and cellulose may be used.

Next, an alkaline dry cell battery of an embodiment of the present invention is described with reference to FIG. 6. FIG. 6 is a front view of an alkaline dry cell battery in an embodiment of the present invention, with a partial cross section. The alkaline dry cell battery comprises cylindrical positive electrode mixture pellets 3, and a gelled negative electrode 6 charged in the hollow of the pellets. A separator 4 is interposed between the positive electrode and the negative electrode. Inside a positive electrode case 1, a nickel plated layer is formed, and on the nickel plated layer, a graphite coating film 2 is formed.

The alkaline dry cell battery is manufactured for example as in below. First, in the positive electrode case 1, a plurality of the short cylindrical positive electrode mixture pellets 3 are inserted in the positive electrode case 1, and a pressure is re-applied to the positive electrode mixture pellets 3. By applying the pressure, the positive electrode mixture pellets 3 are brought into close contact with inside the positive electrode case 1. Then, in the hollow of the positive electrode mixture pellets 3, a separator 4 and an insulating cap 5 are disposed.

Afterwards, to wet the separator 4 and the positive electrode mixture pellets 3, an electrolyte is injected in the hollow. After injecting the electrolyte, a gelled negative electrode 6 is charged inside the separator 4.

Then, a negative electrode current collector 10 formed integrally with a resin-made sealing plate 7, a bottom plate 8 also functioning as a negative electrode terminal, and an insulating washer 9 are inserted in the gelled negative electrode 6. An opening end of the positive electrode case 1 is crimped to the peripheral end of the bottom plate 8, with an end of the resin sealing plate 7 interposed therebetween, to seal the opening of the positive electrode case 1. Lastly, the outer surface of the positive electrode case 1 is covered with an outer label 11 to obtain an alkaline dry cell battery.

The present invention is not limited to the alkaline dry cell battery as described above, and may be applied to a battery with other structures, such as alkaline button type, and prismatic type.

The present invention also relates to a method for manufacturing a nickel oxyhydroxide having a β-type structure: the method comprising a step of:

chemically oxidizing a nickel hydroxide having a β-type structure,

wherein a FWHM of a peak of the (001) plane is 0.15 to 0.49°,

a FWHM of a peak of the (100) plane is 0.15 to 0.3°, and a FWHM of a peak of the (101) plane is 0.2 to 0.6° in a powder X-ray diffraction; and

an average particle size (D₅₀) based on the secondary particle volume of 5 to 10 μm.

The nickel oxyhydroxide having the β-type structure can be obtained for example as in below.

First, nickel hydroxide and a dilute (0.1 mol/L, for example) sodium hydroxide aqueous solution are mixed. To the aqueous solution, for example, sodium hypochlorite as an oxidant is added and stirred to carry out a chemical oxidation, and to obtain a slurry including a nickel oxyhydroxide. Afterwards, washing with water and vacuum drying are carried out, thereby obtaining a nickel oxyhydroxide.

The average particle size of the nickel oxyhydroxide can be controlled by classifying the nickel oxyhydroxide included in the slurry based on for example the difference in precipitation speed in water.

Also, the average valence of nickel in the nickel oxyhydroxide can be controlled by adjusting at least one of a concentration and an amount of the sodium hypochlorite, and a temperature of a reaction atmosphere, for example.

Further, by carrying out a characterization by a powder X-ray diffraction, it can be identified if the nickel oxyhydroxide to be obtained has the β-type structure.

The starting material nickel hydroxide with the β-type structure (β-nickel hydroxide) having the above three powder X-ray diffraction parameters (FWHM s of a peak of the (001) plane, the (100) plane, and the (101) plane) has a high crystallinity. Therefore, in the β-nickel oxyhydroxide obtained by chemically oxidizing the above β-nickel hydroxide as well, a FWHM of a peak of the (001) plane is small, and its crystallinity is high. Therefore, by using the β-nickel oxyhydroxide obtained by the above manufacturing method for manufacturing an alkaline primary battery, low-temperature discharge performance and pulse discharge performance can be improved.

The β-nickel hydroxide with a FWHM of below 0.15° of a peak of the (001) plane, a FWHM of below 0.15° of a peak of the (100) plane, and a FWHM of below 0.2° of a peak of the (101) plane is excessively high in crystallinity, and makes desorption of protons from the crystal by an oxidant at the time of chemical oxidation difficult. Thus, in the obtained nickel oxyhydroxide, the average valence of nickel tends to be small. Also, the above β-nickel hydroxide is extremely difficult to be manufactured. Also, by using the β-nickel hydroxide with a FWHM of more than 0.5° of a peak of the (001) plane, a FWHM of more than 0.3° of a peak of the (100) plane, and a FWHM of more than 0.6° of a peak of the (101) plane, since the β-nickel oxyhydroxide to be obtained has a low crystallinity, sufficient improvement of characteristics cannot be obtained. Therefore, the three powder X-ray diffraction parameters are preferably the values as shown above.

When the average particle size (D₅₀) based on the secondary particle volume of the β-nickel hydroxide (starting material) is below 5 μm, a cycle time of washing with water, filtering, and drying in the chemical oxidation process becomes excessively long, making a mass production difficult. Also, when D₅₀ is more than 10 μm, the chemical oxidation by an oxidant does not sufficiently advance to the inside secondary particles. Therefore, D₅₀ of the secondary particles of the β-nickel hydroxide is preferably 5 to 10 μm.

The above nickel hydroxide can be obtained for example as in below.

An aqueous solution including ammonia and ammonium sulfate is prepared. The ammonia concentration is preferably 1.5 to 5 mol/L. The ammonium sulfate concentration is preferably 0.02 to 0.1 mol/L. To the aqueous solution, for example, an aqueous ammonia solution is added while stirring, to keep the pH of 10.5. With regard to the temperature of the aqueous solution, 30 to 70° C. will suffice. Nickel powder is added to this aqueous solution to obtain a suspension. When an oxidation-reduction potential of the suspension reached for example approximately −600 mV, oxygen is supplied and the mixture is stirred to obtain a slurry including a nickel hydroxide. The oxygen is preferably supplied for 5 to 20 hours. After removing unreacted metallic nickel from the slurry, the slurry is put into a sodium hydroxide aqueous solution. Heating is carried out to remove sulfuric acid ions and remained ammonia. After washing with water, a vacuum drying is carried out, to obtain a nickel hydroxide.

The crystallinity of the nickel hydroxide can be controlled for example by adjusting the concentration of ammonia and ammonium sulfate.

The β-nickel hydroxide with a BET specific surface area of 3 m²/g or more renders production of nickel hydroxide easy. Also, with the BET specific surface area of 10 m²/g or less, liquid can be kept appropriately, and troubles that may occur in filtering and drying steps in the chemical oxidation process may be retarded. Therefore, the BET specific surface area of the β-nickel hydroxide is preferably 3 to 10 m²/g.

Upon preparing the nickel oxyhydroxide, it is preferred that the nickel hydroxide includes a metallic nickel in an amount of 0.03 to 1 wt % relative to a total weight of the nickel hydroxide. By using the nickel hydroxide and the metallic nickel, electron conductivity of the nickel oxyhydroxide powder to be obtained further improve. As a result, excellent low-temperature discharge performance can be obtained. The metallic nickel content of 0.03% or more relative to a total weight of the nickel hydroxide achieves further excellent discharge performance. The content of 1 wt % or less achieves keeping the proportion of the nickel oxyhydroxide in the positive electrode.

Also, the nickel hydroxide is preferably a solid solution including at least one of cobalt and manganese in an amount of 0.1 to 10 mol % relative to a total amount of the metal element included in the nickel hydroxide. The cobalt and manganese included in the solid solution of the nickel hydroxide decreases the oxidation-reduction potential of the nickel hydroxide, and has an effect of increasing an oxygen overvoltage. Therefore, the chemical oxidation process advances easier. As a result, variations in oxidation degree by every lot of the nickel oxyhydroxide can be decreased. By using this nickel oxyhydroxide, reliability on alkaline primary batteries will also improve.

When the content of at least one of cobalt and manganese in the solid solution of the nickel hydroxide is 0.1 mol % or more, excellent effects as described above can be obtained. Also, when the content is 10 mol % or less, in the nickel oxyhydroxide to be obtained, the proportion of nickel contributing to discharge can be kept. As a result, an excellent battery capacity can be obtained. Therefore, the content of at least one of cobalt and manganese in the solid solution of the nickel hydroxide is preferably 0.1 to 10 mol %.

To obtain the solid solution of the nickel hydroxide including at least one of cobalt and manganese, for example, in the above step of obtaining the nickel hydroxide, at least one of cobalt powder and manganese powder is added upon adding the nickel powder. Afterwards, in the same manner as the above, the solid solution of the nickel hydroxide including at least one of cobalt and manganese can be obtained.

In the following, Examples of the present invention are described in detail. However, the present invention is not limited to these Examples.

### EXAMPLE

### Experimental Example 1

(1) Synthesis of Nickel Hydroxide

To a reaction vessel (2L) comprising a stirring wing, an oxygen sparger, a pH electrode, a potential-measuring electrode, and a thermometer, 2L of an aqueous solution including 2 mol/L of ammonia and 0.05 mol/L of ammonium sulfate was placed. A 25 wt % ammonia water is added and stirred appropriately so that pH of the aqueous solution was kept to 10.5, and the temperature was kept to 50° C. under atmospheric pressure. To this aqueous solution, a linear nickel powder obtained by a thermal decomposition of carbonyl nickel (type 255: manufactured by INCO) was added in an amount of 250 g to obtain a suspension. The nickel was activated in this step. From the point when an oxidation-reduction potential of the above suspension reached approximately −600 mV (vs SCE), an oxygen supply (50 mL/min) from an oxygen sparger was started. The oxygen supply was carried out for 15 hours, to obtain a slurry including a nickel hydroxide. Unreacted metallic nickel powder was removed from the slurry by using a magnet. The remained slurry was heated in a sodium hydroxide aqueous solution, to remove sulfuric acid ions and remained ammonia. Afterwards, washing with water and drying under vacuum were carried out (60° C., 24 hours) to obtain nickel hydroxide “a” as a starting material.

Also, as a general crystallization, in a reaction vessel having a stirring wing different from the above vessel, 2 mol/L of a sulfuric acid nickel (II) aqueous solution, 4 mol/L of a sodium hydroxide aqueous solution, and 2 mol/L of ammonia water were supplied in a constant amount by a pump. The stirring was carried out so that the pH and the temperature in the reaction vessel became constant (pH=12.0, temperature: 50° C.). A spherical nickel hydroxide is thereby deposited and grown. Thus obtained particles were heated in a sodium hydroxide aqueous solution different from the above to remove sulfuric acid ions and remained ammonia, and washing with water and drying under vacuum (60° C., 24 hours) were carried out, to make it into nickel hydroxide “b” as a starting material.

For the nickel hydroxides “a” and “b”, a powder X-ray diffraction was carried out, and a volume-based average particle size (D₅₀) and a BET specific surface area were determined. As a measuring device, for the powder X-ray diffraction, a powder X-ray diffraction device “RINT2500” manufactured by Rigaku Corporation was used. For the average particle size, a particle size distribution analyzer “LA-920” manufactured by Horiba Ltd was used. For the BET specific surface area, “ASAP2010” manufactured by Shimadzu Corporation was used. The obtained powder X-ray diffraction profile is shown in FIG. 4. The results of the various measurements are also shown in Table 1.

TABLE 1

| | | | | Volume- | |
|---|---|---|---|---|---|
| | | | | based | |
| | Powder X-Ray Diffraction | | | Average | BET |
| | FWHM | FWHM | FWHM | Particle | Specific |
| Nickel | (001) | (100) | (101) | Size | Surface |
| Hydroxide No. | [°] | [°] | [°] | D₅₀[μm] | [m2/g] |
| Nickel | 0.2 | 0.19 | 0.25 | 8.4 | 5.2 |
| Hydroxide “a” | | | | | |
| Nickel | 0.56 | 0.28 | 0.54 | 11.3 | 10.5 |
| Hydroxide “b” | | | | | |

The nickel hydroxide “a” obtained by a direct oxidation of a metallic nickel has a smaller FWHM of a peak than the nickel hydroxide “b” obtained by general crystallization. That is, it has a high crystallinity. Additionally, the nickel hydroxide “a” also has a small average particle size and a small BET specific surface area. Also, from the powder X-ray diffraction profile in FIG. 4, it was confirmed that the nickel hydroxide “a” included a small amount of a metallic nickel. From the measurement results by using a vibrating sample magnetometer (VSM), it was determined that the content was 0.10 wt % relative to a total of the nickel hydroxide. In this measurement, a high sensitivity vibrating sample magnetometer, “VSM-P7-15 type”, manufactured by Toei Industry Co., Ltd. was used, and by using a calibration curve on a standard sample, in which a predetermined metallic nickel powder was added, the metallic nickel content in the nickel hydroxide “a” was determined.

(2) Preparation of Nickel Oxyhydroxide

The nickel hydroxide “a” in an amount of 200 g was placed in a 0.1 mol/L sodium hydroxide aqueous solution in an amount of 1 L. As an oxidant, 1.5 equivalents of a sodium hypochlorite aqueous solution (effective chlorine concentration: 10 wt %) was added and stirred, to prepare a nickel oxyhydroxide. The reaction atmosphere temperature (temperature of the solution) was set to 50° C., and the processing time after the addition of the sodium hypochlorite aqueous solution was set to 6 hours. The obtained particles were sufficiently washed with water, and a vacuum drying at 60° C. was carried out for 24 hours to regard it as nickel oxyhydroxide A. Also, nickel oxyhydroxide B was prepared in the same manner as the above, except that the nickel hydroxide “b” was used instead of the nickel hydroxide “a”.

For the nickel oxyhydroxides A and B, a powder X-ray diffraction was carried out, and a volume-based average particle size (D₅₀) and a BET specific surface area were determined. Further, by the above method, an average valence of nickel was determined. The obtained powder X-ray diffraction profile is shown in FIG. 5. Also, the results of various measurements are shown in Table 2.

TABLE 2

| | | Volume- | | |
|---|---|---|---|---|
| | | based | | |
| | FWHM (001) | Average | BET | |
| | in X-ray | Particle | specific | Average |
| Nickel | diffraction | Size | surface | Valence of |
| Oxyhydroxide No. | [°] | D₅₀[μm] | [m²/g] | Nickel |
| Nickel | 0.32 | 8.3 | 5.6 | 2.96 |
| Oxyhydroxide A | | | | |
| Nickel | 0.58 | 11.1 | 13.5 | 2.99 |
| Oxyhydroxide B | | | | |

The nickel oxyhydroxides A and B were both the β-type nickel oxyhydroxide with the nickel valence reaching in the proximity of three. Reflecting the physical properties of the nickel hydroxide as the starting material, the nickel oxyhydroxide A had a higher crystallinity, a smaller particle size, and a smaller BET specific surface area than the nickel oxyhydroxide B. Also, from the powder X-ray diffraction profile of FIG. 5, it was confirmed that in the nickel oxyhydroxide A, a small amount of the metallic nickel was mixed in. From the measurement results by using a vibrating sample magnetometer (VSM), the content was determined as 0.07 wt %. The β-type was confirmed by a powder X-ray diffraction.

An electrolytic manganese dioxide (HHTF manufactured by Tosoh Corporation) (volume-based average particle size: 40 μm), the nickel oxyhydroxide A, and a graphite (SP-20 manufactured by Nippon Graphite Industries, ltd.) (volume-based average particle size: 10 μm) was mixed with a weight ratio of 50:42:8 to obtain a powder mixture. After mixing in 1 part by weight of an electrolyte relative to 100 parts by weight of the powder mixture, the mixture was mixed homogenously by a mixer and arranged to give a uniform grain size. The obtained granules were pressure-molded to give hollow cylindrical positive electrode mixture pellets, and the pellets were used as the positive electrode. For the electrolyte, an aqueous solution of 40 wt % potassium hydroxide was used.

For the negative electrode, a gelled negative electrode obtained by mixing a gelling agent, an electrolyte, and a negative electrode active material, and carrying out a conventional gelling process was used.

For the gelling agent, sodium polyacrylate (JUNLON PW-150 manufactured by Nihon Junyaku Co., Ltd.) was used. For the negative electrode active material, a zinc powder with an average particle size of 130 μm was used.

For the separator, a composite non-woven fabric of vinylon-refined cellulose (LYOCELL (trade name)) manufactured by Kuraray Co., Ltd. was used.

(3) Battery Production and Evaluation

By using the above positive electrode mixture pellets, an alkaline dry cell battery as shown in FIG. 6 was made. First, in the positive electrode case 1, a plurality of hollow cylindrical positive electrode mixture pellets 3 were placed. By re-applying a pressure to the positive electrode mixture pellets 3 in the positive electrode case 1, the pellets were brought into close contact with inside of the positive electrode case 1. Then, after placing a separator 4 and an insulating cap 5 inside the positive electrode mixture pellets 3, an electrolyte was injected. After the injection, a gelled negative electrode 6 was charged inside the separator 4.

Then, a negative electrode current collector 10 integrally formed with a resin-made sealing plate 7, a bottom plate 8 also functioning as a negative electrode terminal, and an insulating washer 9 was inserted in the gelled negative electrode 6. Then, an opening end of the positive electrode case 1 was crimped to a peripheral end of the bottom plate 8 with a sealing plate 7 interposed therebetween, to seal the opening of the positive electrode case 1. Lastly, the outermost face of the positive electrode case 1 was covered with an outer label 11, thereby producing an alkaline dry cell battery (battery A).

Also, alkaline dry cell battery B was made in the same manner as the above, except that the nickel oxyhydroxide B was used instead of the nickel oxyhydroxide A.

For an evaluation of low-temperature discharge performance of alkaline dry cell batteries, the batteries A and B (fresh batteries) were continuously discharged at an atmosphere of 0° C. with a constant electric power of 1000 mW, and a discharge-time until the battery voltage reached 0.9 V was measured.

Also, for an evaluation of pulse discharge performance under high-load, the following cycle was repeated until the lower-limit voltage of a pulse discharge with 1500 mW reached 1.05 V, and the number of cycles was evaluated: the batteries A and B (fresh batteries) were discharged with a constant electric power of 650 mW for 28 seconds at an atmosphere of 20 ° C., and a pulse discharge was carried out for 2 seconds at a constant electric power of 1500 mW. The obtained results are shown in Table 3, setting the values of battery B as 100.

TABLE 3

| | | 0° C., 1000 mW | 650 mW/1500 mW |
|---|---|---|---|
| | | Discharge-time | Number of |
| | | <Low temperature | Discharge Cycle |
| Battery No. | | Discharge> | <Pulse Discharge> |
| Alkaline | Present | 115 | 110 |
| Dry Cell | Invention | | |
| Battery A | | | |
| Alkaline | Comparative | 100 | 100 |
| Dry Cell | Example | | |
| Battery B | | | |

It is clear that the alkaline dry cell battery A of the present invention achieves excellent performance in both low-temperature discharge performance and pulse discharge performance under high-load. This is probably because of the differences in physical properties of the nickel oxyhydroxides used: in the case where the nickel oxyhydroxide A was used, the performance improved mainly based on the reasons (a) to (d) below.

(a) Difference in Crystallinity

In the nickel oxyhydroxide A having a very small FWHM of 0.320° of a peak of the (001) plane in a powder X-ray diffraction, the layer structure of the primary particles (crystallite) is developed along the c-axis direction. Therefore, the nickel oxyhydroxide A is advantageous in discharge under high-load (high-speed reduction reaction) than the nickel oxyhydroxide B, in view of both proton diffusibility (probability of presence of edge plane) and electron conductivity.

(b) Difference in Average Particle Size

The nickel oxyhydroxide A has a small volume-based average particle size (D₅₀) of 8.3 μm. Therefore, upon producing the positive electrode mixture, it is highly mixed with a graphite conductive agent, and excellent conductive network is formed, compared with the battery using the nickel oxyhydroxide B. Therefore, it gives advantageous effects on low-temperature discharge performance and pulse discharge performance under high-load.

(c) Difference in Specific Surface Area

The nickel oxyhydroxide A has a small BET specific surface area of 5.6 m²/g. Therefore, the liquid retention degree in the positive electrode pellets is low, and the positive electrode pellets hardly swell at the time of the electrolyte injection. Therefore, decline in electrical contacts between the positive electrode mixture particles can be retarded. Thus, compared with the battery using the nickel oxyhydroxide B in which the positive electrode pellets swell with relative ease, low-temperature discharge performance and pulse discharge performance under high-load can be kept to a high level.

(d) Metallic Nickel Presence

The nickel oxyhydroxide A includes a small amount of a metallic nickel of about 0.07 wt %. This further improves electron conductivity of the nickel oxyhydroxide powder, and especially, low-temperature discharge performance improves.

### Experimental Example 2

Crystallinity, the average particle size, and the metallic nickel content of the nickel oxyhydroxide were evaluated.

The nickel hydroxide “a” made in Experimental Example 1 in an amount of 5 kg was placed into a 0.1 mol/L sodium hydroxide aqueous solution in an amount of 20 L. A sodium hypochlorite aqueous solution as an oxidant (effective chlorine concentration: 10 wt %) of 1.5 equivalents was added and stirred, for a conversion into a nickel oxyhydroxide. At this time, the reaction atmosphere temperature was set to 50° C., and a processing time after placing the sodium hypochlorite aqueous solution was set to 6 hours. The obtained particles were sufficiently washed with water and filtered to regard it as nickel oxyhydroxide slurry A1. The nickel oxyhydroxide slurry A1 is a scale-up product substantially the same as the nickel oxyhydroxide A made in Experimental Example 1.

The nickel hydroxide “a” in an amount of 5 kg was placed in a 1 mol/L sodium hydroxide aqueous solution in an amount of 20 L. A sodium hypochlorite aqueous solution as an oxidant (effective chlorine concentration: 10 wt %) of 1.5 equivalents was added, and a processing was carried out at 50° C. for 6 hours. Further, sodium peroxodisulfuric acid (sodium persulfuric acid) powder in an amount of 2.0 kg was added and mixed by stirring for 4 hours, and an oxidation process stronger than the above nickel oxyhydroxide slurry A1 was carried out. Thus obtained particles were sufficiently washed with water and filtered, to regard it as nickel oxyhydroxide slurry A2.

The nickel oxyhydroxide slurry obtained above was classified by using a classifier “Hydroplex 63AHP” manufactured by Hosokawa Micron Group, based on the difference in the precipitation speed. The nickel oxyhydroxide slurry A1 was supplied to a classifying rotor of the device, and the grain size to be classified was adjusted (5 levels) by adjusting the rotation speed of the rotor and the flow rate. The classified slurry was dried under vacuum at 60° C. for 24 hours, to obtain nickel oxyhydroxide having different average particle sizes: A11 (D₅₀: about 12 μm), A12 (D₅₀: about 10 μm), A13 (D₅₀: about 8 μm), A14 (D₅₀: about 5 μm), and A15 (D₅₀: about 3 μm). For the nickel oxyhydroxide slurry A2 as well, the classification was carried out in the same manner as the above, to obtain nickel oxyhydroxides A21 to A25 having different average particle sizes.

For the nickel oxyhydroxides A11 to A15 and A21 to A25, and for the nickel oxyhydroxide B (made in Experimental Example 1) for the comparison, a powder X-ray diffraction was carried out, and a volume-based average particle size (D₅₀) and a BET specific surface area were determined. The average valence of nickel was determined as well. Further, by using a vibrating sample magnetometer (VSM), the metallic nickel content was determined. The measurement results are shown in Table 4.

TABLE 4

| | FWHM (001) | | | | Metallic |
|---|---|---|---|---|---|
| | in X-ray | Volume-based | BET Specific | Nickel | Nickel |
| | diffraction | Average Particle | Surface Area | Average | Content |
| Nickel Oxyhydroxide No. | [°] | Size D₅₀[μm] | [m²/g] | Valence | [wt %] |
| Nickel Oxyhydroxide A11 | 0.19 | 12.1 | 2.5 | 2.89 | 0.07 |
| Nickel Oxyhydroxide A12 | 0.2 | 9.8 | 3 | 2.90 | 0.06 |
| Nickel Oxyhydroxide A13 | 0.31 | 7.9 | 6.1 | 2.96 | 0.05 |
| Nickel Oxyhydroxide A14 | 0.33 | 5 | 9.3 | 2.98 | 0.03 |
| Nickel Oxyhydroxide A15 | 0.34 | 3.5 | 11.2 | 2.99 | 0.03 |
| Nickel Oxyhydroxide A21 | 0.41 | 11.8 | 2.8 | 2.97 | 0.02 |
| Nickel Oxyhydroxide A22 | 0.44 | 10.0 | 3.9 | 2.99 | 0.02 |
| Nickel Oxyhydroxide A23 | 0.45 | 8.1 | 7.3 | 2.99 | 0.02 |
| Nickel Oxyhydroxide A24 | 0.49 | 5.3 | 10.0 | 3 | 0.01 |
| Nickel Oxyhydroxide A25 | 0.52 | 3.1 | 12.9 | 3 | 0.01 |
| Nickel Oxyhydroxide B | 0.58 | 11.1 | 13.5 | 2.99 | 0 |

In the nickel oxyhydroxides A21 to A25, in which a stronger oxidation process was carried out, a FWHM of a peak of the (001) plane increased, and the metallic nickel content decreased. As effects of the classification, it can be mentioned that when the average particle size is large, the FWHM of the peak of the (001) plane becomes smaller, the BET specific surface area becomes smaller, and the average valence of nickel becomes smaller.

Alkaline dry cell batteries A12 to A15, A21 to A25, and B were made in the same manner as Experimental Example 1, except that the nickel oxyhydroxides A11 to A15, A21 to A25, and B were used instead of the nickel oxyhydroxide A.

For the obtained alkaline dry cell batteries, in the same manner as Experimental Example 1, low-temperature discharge performance and pulse discharge performance under high-load were evaluated. The obtained results are shown in Table 5, setting the values of the battery B as 100.

TABLE 5

| | 0° C., 1000 mW | 650 mW/1500 mW |
|---|---|---|
| | Discharge-time | Number of |
| | <Low Temperature | Discharge Cycle |
| Battery No. | Discharge> | <Pulse Discharge> |
| Alkaline Dry Cell | 100 | 99 |
| Battery A11 | | |
| Alkaline Dry Cell | 109 | 107 |
| Battery A12 | | |
| Alkaline Dry Cell | 116 | 110 |
| Battery A13 | | |
| Alkaline Dry Cell | 113 | 108 |
| Battery A14 | | |
| Alkaline Dry Cell | 101 | 100 |
| Battery A15 | | |
| Alkaline Dry Cell | 101 | 100 |
| Battery A21 | | |
| Alkaline Dry Cell | 105 | 103 |
| Battery A22 | | |
| Alkaline Dry Cell | 108 | 104 |
| Battery A23 | | |
| Alkaline Dry Cell | 106 | 103 |
| Battery A24 | | |
| Alkaline Dry Cell | 99 | 99 |
| Battery A25 | | |
| Alkaline Dry Cell | 100 | 100 |
| Battery B | | |

In batteries A12, A13, A14, A22, A23, and A24, excellent low-temperature discharge performance and pulse discharge performance under high-load were obtained. This shows that the preferable physical properties of the nickel oxyhydroxide are the following: in a powder X-ray diffraction, a FWHM of a peak of the (001) plane is 0.2 to 0.49°, a volume-based average particle size (D₅₀) is 5 to 10 μm, and an average valence of nickel is 2.9 to 3.0. When the FWHM of the peak of the (001) plane in a powder X-ray diffraction and the average particle size are in the above range, the BET specific surface area becomes smaller as shown in Table 4.

Also, since the batteries A12, A13, and A14 have better discharge performance than the batteries A22, A23, and A24, in addition to the above physical properties, the nickel oxyhydroxide preferably includes the metallic nickel of 0.03 wt % or more. When the metallic nickel content is large, the proportion of the nickel oxyhydroxide contributing to capacity decreases. Therefore, securing the battery capacity becomes difficult. Although details are omitted, other experiments for verification were conducted in this regard and it was confirmed that the metallic nickel content was preferably kept to the range within 1 wt % at most.

### Experimental Example 3

Experiments were conducted to see the effects when the nickel oxyhydroxide was a solid solution including a metal element (such as cobalt and manganese).

Nickel hydroxide cl of a solid solution including cobalt was obtained in the same manner as Experimental Example 1, except that upon adding the nickel powder, metal cobalt powder was added. The amount to be added was set so that the cobalt content becomes 0.05 mol % relative to a total amount of the metal element included in the nickel hydroxide. Also, nickel hydroxides c2 to c7 were obtained in the same manner as the above, except that the cobalt was added so that the cobalt content relative to a total amount of the metal element included in the nickel hydroxide became 0.1, 1, 3, 7, 10, and 12 mol %.

Also, nickel hydroxides d1 to d7, i.e., a solid solution including manganese and the manganese content relative to a total amount of the metal element included the in the nickel hydroxide was 0.05, 0.1, 1, 3, 7, 10, and 12 mol %, were made in the same manner as the above, except that metal manganese powder (reagent manufactured by Sigma-Aldrich co.) was used instead of the metal cobalt powder.

Nickel oxyhydroxides C1 to C7 and D1 to D7 were obtained in the same manner as Experimental Example 1, except that the above nickel hydroxides c1 to c7 and D1 to D7 were used.

For the nickel oxyhydroxides C1 to C7 and D1 to D7, and comparative nickel oxyhydroxides A and B (both made in Experimental Example 1), a powder X-ray diffraction was carried out, and a volume-based average particle size (D₅₀) and a BET specific surface area were determined. The average valence of nickel was also determined. The measurement results are shown in Table 6.

TABLE 6

| | | Metal | FWHM(001) | | | |
|---|---|---|---|---|---|---|
| | Metal | Element | in X-ray | Volume-based | BET Specific | Nickel |
| | Element | Content | Diffraction | Average Particle | Surface Area | Average |
| Nickel Oxyhydroxide No. | Included | [mol %] | [°] | Size D₅₀[μm] | [m²/g] | Valence |
| Nickel Oxyhydroxide C1 | Co | 0.05 | 0.34 | 8.1 | 5.7 | 2.96 |
| Nickel Oxyhydroxide C2 | | 0.1 | 0.33 | 7.7 | 6.1 | 2.99 |
| Nickel Oxyhydroxide C3 | | 1 | 0.31 | 7.6 | 6.8 | 2.99 |
| Nickel Oxyhydroxide C4 | | 3 | 0.38 | 7.8 | 5.9 | 3.00 |
| Nickel Oxyhydroxide C5 | | 7 | 0.39 | 8.6 | 5.8 | 3.00 |
| Nickel Oxyhydroxide C6 | | 10 | 0.36 | 8.8 | 5.3 | 3.00 |
| Nickel Oxyhydroxide C7 | | 12 | 0.37 | 8.2 | 6.2 | 2.99 |
| Nickel Oxyhydroxide D1 | Mn | 0.05 | 0.31 | 7.9 | 6.3 | 2.97 |
| Nickel Oxyhydroxide D2 | | 0.1 | 0.32 | 8.4 | 5.5 | 2.98 |
| Nickel Oxyhydroxide D3 | | 1 | 0.36 | 8.3 | 5.9 | 2.99 |
| Nickel Oxyhydroxide D4 | | 3 | 0.33 | 7.7 | 6.8 | 3.00 |
| Nickel Oxyhydroxide D5 | | 7 | 0.31 | 7.4 | 6.1 | 3.00 |
| Nickel Oxyhydroxide D6 | | 10 | 0.37 | 7.9 | 6.5 | 3.00 |
| Nickel Oxyhydroxide D7 | | 12 | 0.35 | 8.2 | 5.3 | 3.00 |
| Nickel Oxyhydroxide A | — | — | 0.32 | 8.3 | 5.6 | 2.96 |
| Nickel Oxyhydroxide B | — | — | 0.58 | 11.1 | 13.5 | 2.99 |

When the starting material, i.e., the nickel hydroxide, is a solid solution including cobalt or manganese, compared with the nickel oxyhydroxide A not including cobalt or manganese, there are no great change shown in the FWHM of the peak of the (001) plane, the average particle size, and the BET specific surface area. However, the average valence of nickel was improved to the value in the proximity of three. This is probably because by including cobalt or manganese in the nickel hydroxide, the oxidation-reduction potential of the nickel hydroxide decreased, and oxygen overvoltage increased, thereby making the advancement of the chemical oxidation easier.

Alkaline dry cell batteries C1 to C7, D1 to D7, and A and B were made in the same manner as Experimental Example 1, except that the above nickel oxyhydroxide powders C1 to C7, D1 to D7, and A and B were used.

For the obtained alkaline dry cell batteries, in the same manner as Experimental Example 1, low-temperature discharge performance and pulse discharge performance under high-load were evaluated. Further, the batteries stored in an atmosphere of 60° C. for one week were evaluated as well. The obtained results are shown in Table 7, setting the values of battery B as 100.

TABLE 7

| | | | Fresh Battery | | 60° C., After Storage of 1 Week | |
|---|---|---|---|---|---|---|
| | | Metal | 0° C., 1000 mW | 650 mW/1500 mW | 0° C., 1000 mW | 650 mW/1500 mW |
| | Metal | Element | Discharge-time | Number of | Discharge-time | Number of |
| | Element | Content | <Low Temperature | Discharge Cycle | <Low Temperature | Discharge Cycle |
| Battery No. | Included | [mol %] | Discharge> | <Pulse Discharge> | Discharge> | <Pulse Discharge> |
| Alkaline Dry Cell Battery C1 | Co | 0.05 | 114 | 110 | 103 | 101 |
| Alkaline Dry Cell Battery C2 | | 0.1 | 116 | 113 | 111 | 110 |
| Alkaline Dry Cell Battery C3 | | 1 | 118 | 115 | 114 | 112 |
| Alkaline Dry Cell Battery C4 | | 3 | 122 | 116 | 117 | 114 |
| Alkaline Dry Cell Battery C5 | | 7 | 119 | 113 | 115 | 114 |
| Alkaline Dry Cell Battery C6 | | 10 | 117 | 112 | 110 | 110 |
| Alkaline Dry Cell Battery C7 | | 12 | 103 | 102 | 103 | 102 |
| Alkaline Dry Cell Battery D1 | Mn | 0.05 | 114 | 110 | 103 | 102 |
| Alkaline Dry Cell Battery D2 | | 0.1 | 118 | 112 | 110 | 110 |
| Alkaline Dry Cell Battery D3 | | 1 | 119 | 115 | 112 | 113 |
| Alkaline Dry Cell Battery D4 | | 3 | 120 | 115 | 116 | 112 |
| Alkaline Dry Cell Battery D5 | | 7 | 118 | 114 | 117 | 113 |
| Alkaline Dry Cell Battery D6 | | 10 | 117 | 111 | 111 | 111 |
| Alkaline Dry Cell Battery D7 | | 12 | 104 | 101 | 104 | 102 |
| Alkaline Dry Cell Battery A | — | — | 115 | 110 | 103 | 102 |
| Alkaline Dry Cell Battery B | — | — | 100 | 100 | 100 | 100 |

The batteries C1 to C7, and D1 to D7, wherein the nickel oxyhydroxide including cobalt or manganese was used, achieved better performance than the comparative battery B. The batteries in which the content of cobalt or manganese was 0.1 to 10 mol % (C2 to C6, D2 to D6), the performance improved more than the battery (battery A) in which the nickel oxyhydroxide not including cobalt or manganese was used.

The performance improvement at the initial stage was probably because, in addition to the higher nickel valence of the nickel oxyhydroxide as mentioned above, by including cobalt or manganese in the nickel oxyhydroxide, both the proton diffusibility in crystal at the time of discharge and electron conductivity of crystal were improved. Also, the performance improvement after the storage was probably because, due to the effects from cobalt or manganese included in the nickel oxyhydroxide, the oxygen overvoltage of the nickel oxyhydroxide was increased, and self-discharging of the nickel oxyhydroxide was retarded.

Therefore, the cobalt or manganese content in the nickel oxyhydroxide is preferably 0.1 to 10 mol %.

### Experimental Example 4

The physical properties (crystallinity, average particle size, BET specific surface area) of the starting material, i.e., the nickel hydroxide, were examined.

Nickel hydroxides “e” to “h” were made in the same manner as Experimental Example 1, except that concentrations of ammonia and ammonium sulfate in the aqueous solution, and the reaction temperatures were set as shown in Table 8.

For the nickel hydroxides “e” to “h”, a powder X-ray diffraction was carried out, and a volume-based average particle size (D₅₀) and a BET specific surface area were determined. The measurement results are shown in Table 8. It shows that by adjusting the concentrations of ammonia and ammonium sulfate, and the reaction temperature at the time of synthesizing, crystallinity, the average particle size, and the BET specific surface area can be controlled to a certain degree.

TABLE 8

| | Synthesis Conditions | | | | | | | |
|---|---|---|---|---|---|---|---|---|
| | | Ammonium | | Powder X-ray Diffraction | | | | BET |
| | Ammonia | Sulfate | Reaction | FWHM | FWHM | FWHM | Volume-based | Specific |
| Nickel | Concentration | Concentration | Temperature | (001) | (100) | (101) | Average Particle | Surface |
| Hydroxide No. | [mol/L] | [mol/L] | [° C.] | [°] | [°] | [°] | Size D₅₀[μm] | [m²/g] |
| Nickel | 2 | 0.05 | 40 | 0.19 | 0.18 | 0.24 | 9.1 | 3.9 |
| Hydroxide e | | | | | | | | |
| Nickel | 8 | 0.2 | 40 | 0.45 | 0.27 | 0.52 | 5.8 | 9.1 |
| Hydroxide f | | | | | | | | |
| Nickel | 1.2 | 0 | 50 | 0.14 | 0.14 | 0.18 | 10.3 | 2.8 |
| Hydroxide g | | | | | | | | |
| Nickel | 12 | 0.2 | 80 | 0.54 | 0.35 | 0.62 | 4.7 | 10.5 |
| Hydroxide h | | | | | | | | |

Nickel oxyhydroxides E to H were made in the same manner as Experimental Example 1, except that the above nickel hydroxides “e” to “h” were used.

For the nickel oxyhydroxides E to H, a powder X-ray diffraction was carried out, and a volume-based average particle size (D₅₀) and a BET specific surface area were determined. The average valence of nickel was determined as well. The measurement results are shown in Table 9.

TABLE 9

| | | Volume- | | |
|---|---|---|---|---|
| | | based | | |
| | FWHM (001) | Average | BET | |
| | in X-ray | Particle | Specific | Nickel |
| Nickel | Diffraction | Size | Surface | Average |
| Oxyhydroxide No. | [°] | D₅₀[μm] | [m²/g] | Valence |
| Nickel | 0.29 | 9.2 | 3.8 | 2.95 |
| Oxyhydroxide E | | | | |
| Nickel | 0.48 | 5.6 | 9.5 | 2.98 |
| Oxyhydroxide F | | | | |
| Nickel | 0.19 | 10.4 | 2.7 | 2.88 |
| Oxyhydroxide G | | | | |
| Nickel | 0.58 | 4.3 | 11.5 | 2.99 |
| Oxyhydroxide H | | | | |

In any of the materials, the half-width of the peak of the (001) plane tends to become slightly larger by the oxidation. Also, when the nickel hydroxide “g”, i.e., the one with high crystallinity and a large average particle size, was used as the starting material (nickel oxyhydroxide G), sufficiently increasing the nickel valence was difficult.

Alkaline dry cell batteries E to H were made in the same manner as Experimental Example 1, except that the above nickel oxyhydroxide powders E to H were used.

For the obtained alkaline dry cell batteries, in the same manner as Experimental Example 1, low-temperature discharge performance and pulse discharge performance under high-load were evaluated. The obtained results are shown in Table 10, setting the values of the battery B (used in Experimental Example 1) as 100.

TABLE 10

| | 0° C. 1000 mW | 650 mW/1500 mW |
|---|---|---|
| | Discharge-time | Number of |
| | <Low Temperature | Discharge Cycle |
| Battery No. | Discharge> | <Pulse Discharge> |
| Alkaline Dry Cell | 114 | 110 |
| Battery E | | |
| Alkaline Dry Cell | 109 | 107 |
| Battery F | | |
| Alkaline Dry Cell | 96 | 94 |
| Battery G | | |
| Alkaline Dry Cell | 99 | 98 |
| Battery H | | |

The alkaline dry cell batteries E and F achieved excellent performance. On the other hand, performance of the alkaline primary batteries G and H declined. This shows that the preferable powder physical properties of the starting material nickel hydroxide (β-type) are as follows:

in a powder X-ray diffraction, a half-width of a peak of the (001) plane is 0.15 to 0.5°, a half-width of a peak of the (100) plane is 0.15 to 0.3°, a half-width of a peak of the (101) plane is 0.2 to 0.6°, a volume-based average particle size (D₅₀) is 5 to 10 μm, and a BET specific surface area is 3 to 10 m²/g.

Additionally, the nickel oxyhydroxide H (the starting material nickel hydroxide “h”) has a small particle size, and a large BET specific surface area: therefore, the cycle time for washing with water, filtration, and drying at the time of chemical oxidation process became excessively longer. Also, at the time of molding the positive electrode pellets, the productivity declined by troubles such as chipping of the pellets. In view of such concern on productivity as well, the above physical property range of the nickel oxyhydroxide and the nickel hydroxide are most appropriate.

### INDUSTRIAL APPLICABILITY

An alkaline primary battery of the present invention is excellent in low-temperature discharge performance and pulse discharge performance under high-load: therefore, the alkaline primary battery of the present invention can be used as a power source for digital devices involving a larger power consumption (such as digital cameras), for which conventional dry cell batteries have been used but insufficient.

Although the present invention has been described in terms of the presently preferred embodiments, it is to be understood that such disclosure is not to be interpreted as limiting. Various alterations and modifications will become apparent to those skilled in the art to which the present invention pertains, after having read the above disclosure. Accordingly, it is intended that the appended claims be interpreted as covering all alterations and modifications as fall within the true spirit and scope of the invention.

1. A nickel oxyhydroxide having a β-type structure, wherein a half-width of a peak of the (001) plane is 0.2 to 0.49° in a powder X-ray diffraction,
an average particle size (D₅₀) based on a secondary particle volume is 5 to 10 μm, and
an average valence of nickel is 2.9 to 3.0.

2. The nickel oxyhydroxide in accordance with claim 1, wherein a BET specific surface area is 3 to 10 m²/g.

3. The nickel oxyhydroxide in accordance with claim 1, further comprising 0.03 to 1 wt % of a metallic nickel relative to a total weight of said nickel oxyhydroxide.

4. The nickel oxyhydroxide in accordance with claim 1, comprising a solid solution including at least one of cobalt and manganese in an amount of 0.1 to 10 mol % relative to a total amount of a metal element included in said nickel oxyhydroxide.

5. A method for manufacturing a nickel oxyhydroxide having a β-type structure, the method comprising a step of:
chemically oxidizing a nickel hydroxide having a β-type structure,
wherein a half-width of a peak of the (001) plane is 0.15 to 0.49°, a half-width of a peak of the (100) plane is 0.15 to 0.3°, and a half-width of a peak of the (101) plane is 0.2 to 0.6° in a powder X-ray diffraction; and
an average particle size (D₅₀) based on a secondary particle volume is 5 to 10 μm.

6. The method for manufacturing a nickel oxyhydroxide in accordance with claim 5, wherein said nickel hydroxide has a BET specific surface area of 3 to 10 m²/g.

7. The method for manufacturing a nickel oxyhydroxide in accordance with claim 5, wherein said nickel hydroxide includes 0.03 to 1 wt % of a metallic nickel relative to a total weight of said nickel hydroxide.

8. The method for manufacturing a nickel oxyhydroxide in accordance with claim 5, wherein said nickel hydroxide is a solid solution including at least one of cobalt and manganese in an amount of 0.1 to 10 mol % relative to a total amount of a metal element included in said nickel hydroxide.

9. An alkaline primary battery comprising:
a positive electrode containing a nickel oxyhydroxide having a β-type structure in which a half-width of a peak of the (001) plane is 0.2 to 0.49° in a powder X-ray diffraction, an average particle size (D₅₀) based on a secondary particle volume is 5 to 10 μm, and average valence of nickel is 2.9 to 3.0.
